(19) United States
(12) Patent Application Publication
(10) Pub. No.: US 2025/0130043 A1
(43) Pub. Date: Apr. 24, 2025

(54) Vehicle Leveling System and Method for Leveling Vehicles Using Audible or Human Sensory Feedback

(71) Applicant: FBA Operating Co., Dallas, TX (US)

(72) Inventors: Charles Anthony Leonard, Granite Falls, NC (US); Mark Nelson, Palmdale, CA (US); Barbara Timm-Brock, San Jose, CA (US)

(73) Assignee: FBA Operating Co., Dallas, TX (US)

(21) Appl. No.: 18/891,224

(22) Filed: Sep. 20, 2024

Related U.S. Application Data
(60) Provisional application No. 63/592,858, filed on Oct. 24, 2023.

(51) Int. Cl. G01C 9/04; B60P 3/36; G01C 25/00

(52) U.S. Cl. CPC G01C 9/04; G01C 25/00; B60P 3/36

(57) ABSTRACT

A vehicle leveling system has a sensor for sensing a level state of a vehicle based on a calibration state. The sensor can be one or more position-sensing capable devices mounted to one or more side surfaces of the vehicle. A smart device in communication with the sensor provides audible or human sensory feedback as to the level state of the vehicle. The audible or human sensory feedback can be an audible tone with a varying frequency. The audible or human sensory feedback can be voice, light, haptic, or any other communication capable of human perception. The audible or human sensory feedback provides the user with information needed to set leveling devices, such as jacks, to the proper height and distribution to level the vehicle. The audible or human sensory feedback simplifies and reduces the time needed to achieve a level state of the vehicle.

### CLAIM OF DOMESTIC PRIORITY

The present application claims the benefit of U.S. Provisional Application No. 63/592,858, filed Oct. 24, 2023, which application is incorporated herein by reference.

### FIELD OF THE INVENTION

The present invention generally relates to a vehicle leveling system for leveling vehicles, and more particularly, to a leveling system for leveling vehicles, such as recreational vehicles, using audible or other human sensory feedback.

### BACKGROUND

Whether in a storage or use state, a recreational vehicle (RV) should be leveled for both practical and technical reasons. Practical reasons include a level floor, proper door swings, stove, and sink use, as well as many others. Technical reasons include proper operation of the ammonia-based refrigerator, level holding tanks for proper level detection by electronic means and for the proper operation of the plumbing and various other systems. Some higher-end Class A RVs have onboard leveling systems that utilize digital sensors and hydraulic jacks, but most do not have any native leveling capability beyond the raising and lowering of the front of the RV using manual or electric jacks. Level indicators are generally bubble levels attached to both the side and front or rear of the RV. In addition, there are many other vehicles and trailers that require a level position to operate properly such as food vending trucks, mobile medical transport and trailers, transport trailers and in some cases heavy equipment, although there are many others.

The described device provides leveling indication for the two main axes of the RV (side-to-side and front-to-back). For the purposes of describing both the typical and proposed leveling method, each will be defined as the angle of the RV from front to back and roll will be defined as the angle of the RV from side to side.

Once the RV has been moved into the desired location and orientation for use, the driver typically exits the RV or tow vehicle to inspect the current level condition of the RV by using the bubble levels attached to the RV. The first step can be to level the roll of the RV. Typically, the roll level is done by driving or towing the appropriate RV wheels onto a board, block or other object to raise one side of the RV closer to level. Since the bubble levels being used do not give any exact information regarding the amount that the RV is out of level, it is an educated guess, at best, to determine just how high the appropriate wheels must be raised. Leveling is commonly a trial and error system requiring the driver to make multiple attempts at raising the appropriate wheels the necessary amount to achieve a level position. Each attempt requires the driver to get back into the vehicle to move the wheels off the previously placed object being used to raise wheels, exit the vehicle to add or take away from the height of the object being used to raise the wheels, enter the vehicle again to drive or tow the wheels back onto the object being used to raise the wheels and finally exiting the vehicle again to check the new roll orientation relative to level. It is common for the leveling process to be repeated several times to achieve even an approximate level roll orientation. If bubble levels are being used to determine a level orientation, it is common knowledge that a bubble between the lines on a bubble level has an error range of 2-3 degrees, a significant error amount as it relates to RVs and can cause doors, plumbing and other objects and systems within the RV to not operate properly.

Once the roll orientation is level, the pitch

orientation leveling operation must be completed. Typically, the bubble level mounted to the side of the RV will be used for pitch leveling. In the case of a towable RV, the pitch level generally involves using the jack(s) on the front of the RV to raise or lower the front of the RV until a level position is achieved. Since the upward travel of the jack(s) is limited, it is sometimes required to place blocks or some other object under the jack to enable the jack(s) to raise the front of the RV high enough to achieve a level position. Placing blocks or other objects under the jack(s) requires the RV to be reattached to the tow vehicle, the jack(s) raised, blocks or objects placed under the jack(s), the jack(s) lowered onto the blocks or objects and then released from the tow vehicle. In the case of a drivable RV, the same iterative process used to level the roll of the RV is necessary to level the pitch of the RV. Again, the leveling process may require many attempts, as in the case of leveling the roll of the RV.

As such, a need exists for a system for easily and inexpensively leveling a recreational vehicle that does not require many attempts to achieve a level balance of the recreational vehicle in both the pitch and the roll directions.

### BRIEF DESCRIPTION OF THE DRAWINGS

FIG. 1 illustrates conventional pitch orientation about an axis of an RV;

FIG. 2 illustrates conventional roll orientation about an axis of the RV;

FIG. 3 illustrates pitch orientation using a sensor device and a smart device;

FIG. 4 illustrates roll orientation using a sensor device and a smart device;

FIG. 5 illustrates a bottom view of the RV with leveling jacks;

FIGS. 6a-6c illustrate further detail of the leveling jack in various positions;

FIG. 7 illustrates a schematic or block diagram of the sensor device on a PCB;

FIG. 8 illustrates a graphical user interface on a smart device to send and receive command and control signals;

FIG. 9 illustrates the graphical user interface on the smart device showing RV setup information;

FIG. 10 illustrates the graphical user interface on the smart device showing other RV setup options;

FIG. 11 illustrates the graphical user interface on the smart device showing pitch and roll feedback or information;

FIG. 12 illustrates the graphical user interface on the smart device showing pitch and roll feedback or information in a cross-hair format;

FIGS. 13a-13b illustrate leveling the RV in the roll orientation using the sensor device and smart device with audible or other human sensory feedback;

FIGS. 14a-14b illustrate leveling the RV in the pitch orientation using the sensor device and smart device with audible or other human sensory feedback;

FIG. 15 illustrates a flow chart of leveling the RV in the roll orientation using the sensor device and smart device with audible or other human sensory feedback;

FIG. 16 illustrates a flow chart of leveling the RV in the pitch orientation using the sensor device and smart device with audible or other human sensory feedback; and

FIG. 17 illustrates leveling another RV in the roll and pitch orientations using the sensor device and smart device with audible or other human sensory feedback.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

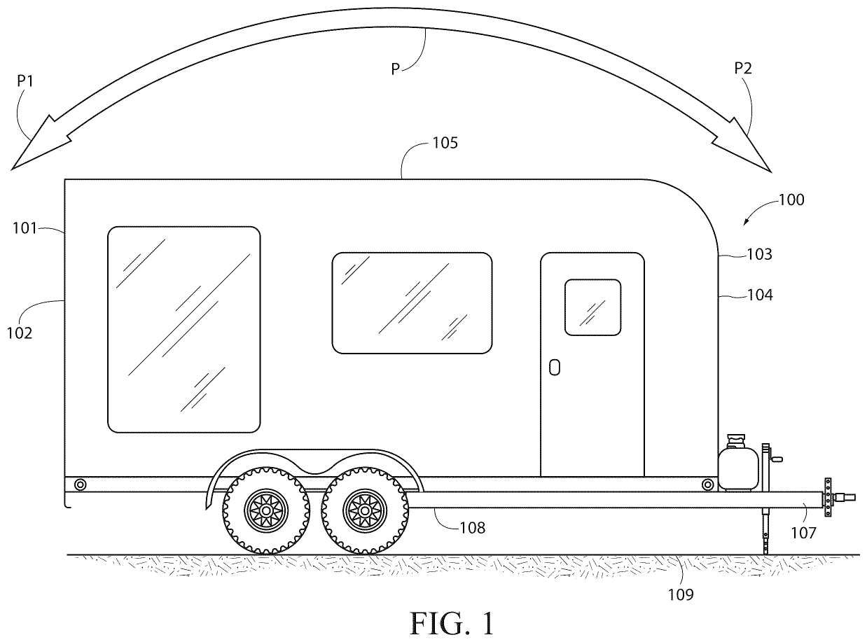

A necessary practice in the use of an RV relates to leveling relative to the two main axes of the RV: pitch being defined as the angle of the RV from front to back about a horizontal axis, and roll being defined as the angle of the RV from side to side about a horizontal axis. When adjusting the pitch, RV 100 can be adjusted in pitch rotational directions P depends on the inclination of the RV from front-to-back, as shown in FIG. 1. Assume a reference point 101 on back 102 and a reference point 103 on front 104. Reference point 101 is the same relative position as reference point 103, e.g., equidistance from top surface 105 or equidistance from bottom surface 108 of RV 100. RV tongue 107 is attached to front 104 for towing. If RV 100 is pitch inclined so that reference point 101 is further from ground 109 than reference point 103, then the pitch of RV 100 can be adjusted in the direction of arrow point P₁ to achieve a level pitch state. If RV 100 is pitch inclined so that reference point 101 is closer to ground 109 than reference point 103, then the pitch can be adjusted in the direction of arrow point P₂ to achieve a level pitch state.

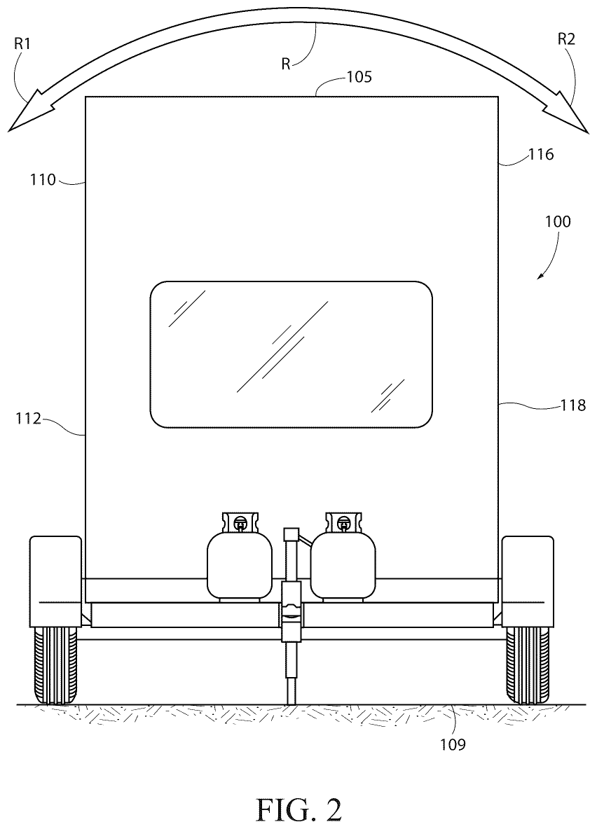

Similarly, as shown in FIG. 2, assume a reference point 110 on side 112 and a reference point 116 on side 118. Reference point 110 is the same relative position as reference point 116, e.g., equidistance from top surface 105 or equidistance from bottom surface 108 of RV 100. When adjusting the roll, RV 100 can be adjusted in roll rotational directions R depending on the inclination of the RV from side-to-side. If RV 100 is roll inclined so that reference point 110 is further from ground 109 than reference point 116, then the roll of RV 100 can be adjusted in the direction of arrow point R₁ to achieve a level roll state. If RV 100 is roll inclined so that reference point 110 is closer to ground 109 than reference point 116, then the roll can be adjusted in the direction of arrow point R₂ to achieve a level roll state.

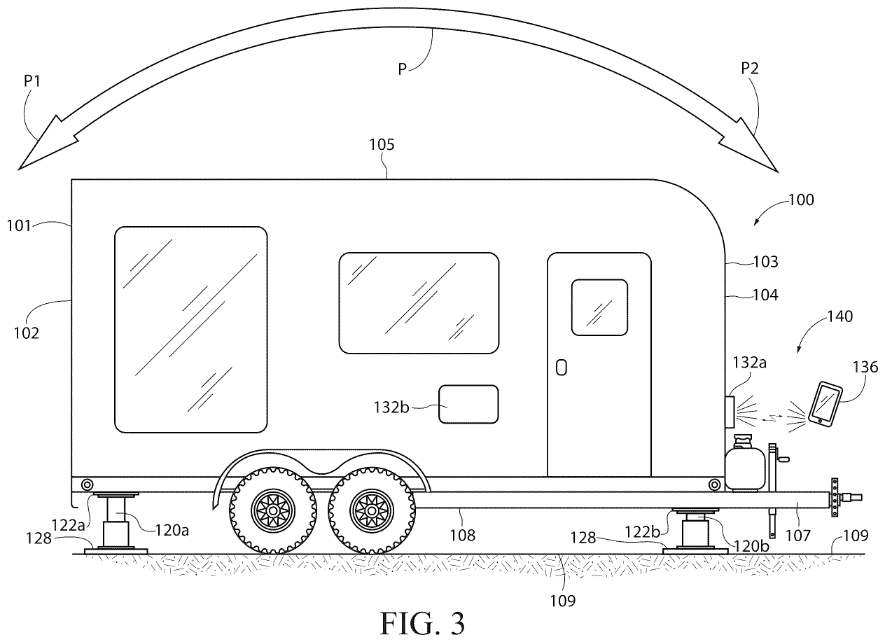

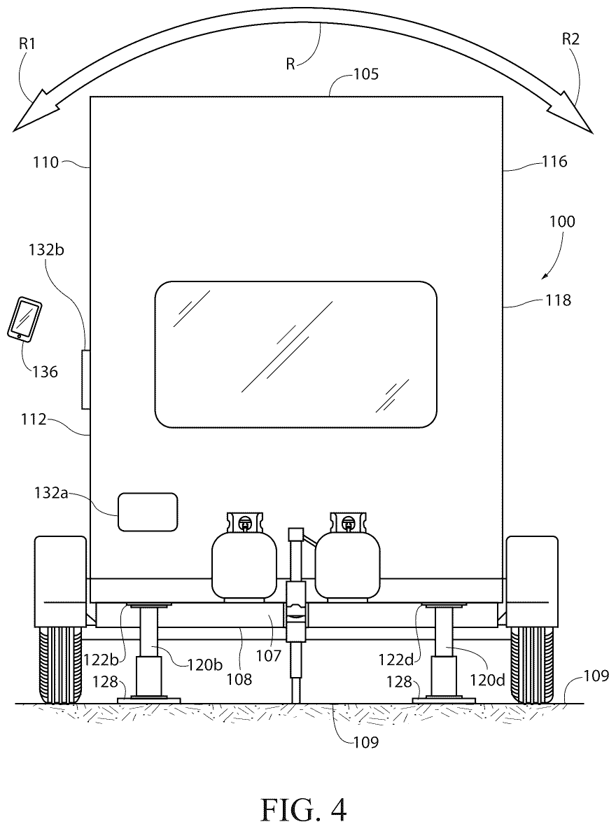

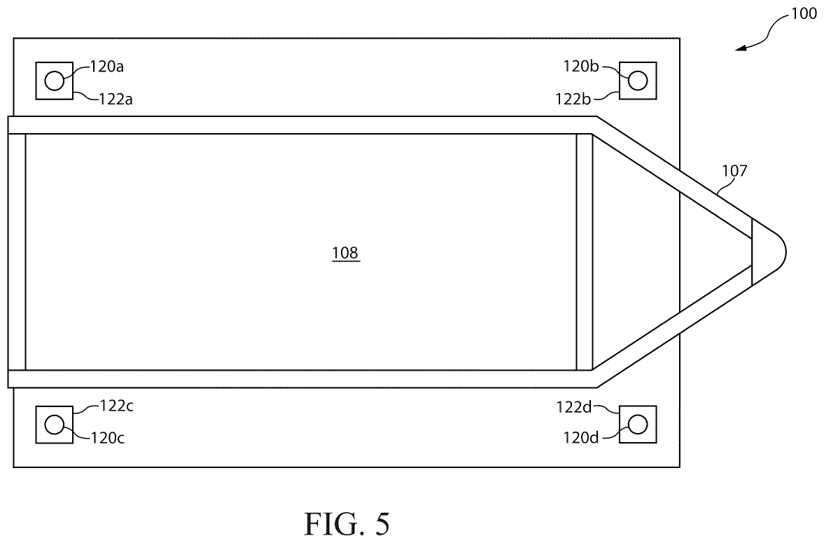

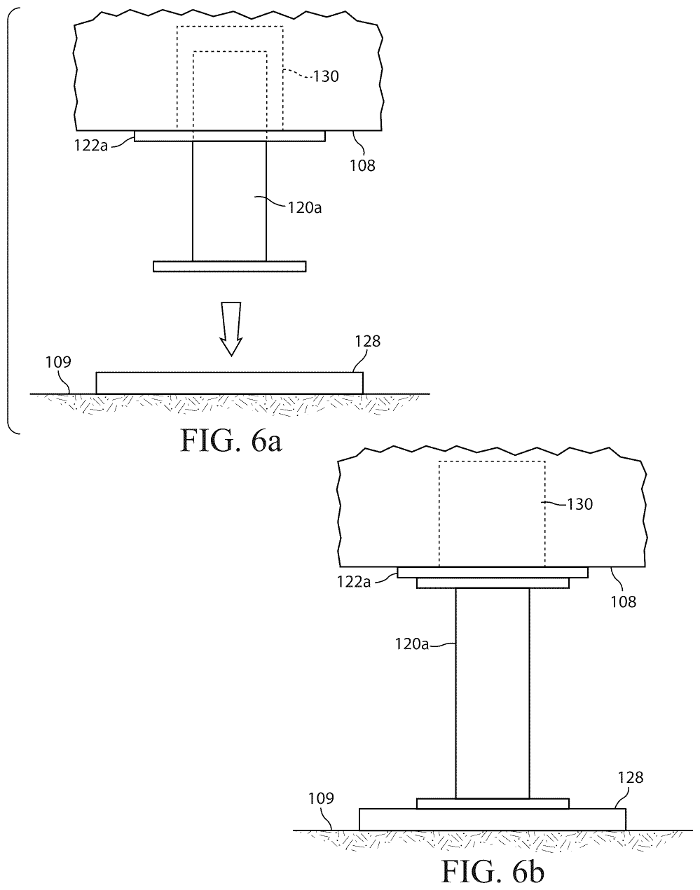

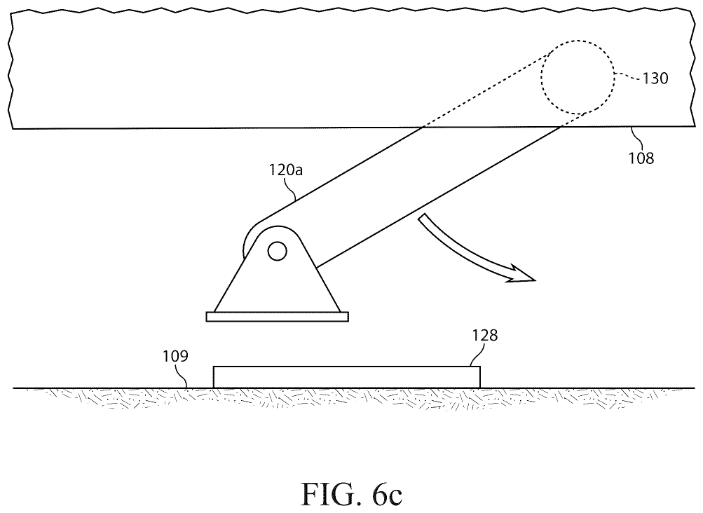

In FIGS. 3 and 4, RV 100 makes use of one or more jacks, such as jacks 120a, 120b, 120c, and 120d at support points 122a, 122b, 122c, and 122d on bottom surface 108. FIG. 5 is a bottom view of RV 100 with jacks 120a-120d and support points 122a-122d. Looking towards side 104 from the front of RV 100, jack 120a is designated as the left rear (LR) jack, jack 120b is designated as the left front (LF) jack, jack 120c is designated as the right rear (RR) jack, and jack 120d is designated as the right front (RF) jack. Jacks 120a-120d can be implemented in a variety of forms. Jacks 120a-120d can be hand-held and placed between support points 122a-122d and ground 109 or support blocks 128. Jacks 120a-120d can be mounted within RV 100 and move vertically downward to ground 109 or support blocks 128, as shown in FIG. 6a. FIG. 6b shows jacks 120a-120d fully extended. Jacks 120a-120d can be mounted within RV 100 and rotate downward toward ground 109 or support blocks 128, as shown in FIG. 6c. Jacks 120a-120d can be hand-operated or placed in motion or operated by motor 130. Motor 130 can be screw-driven, hydraulic, electric, magnetic, or other type of prime mover.

Returning to FIGS. 3 and 4, one or more sensor devices 132 are mounted to RV 100, shown individually or collectively as sensor device 132a and sensor device 132b. Sensor device 132 can be mounted to back 102, front 104, side 112, and/or side 118. Sensor device 132 can be mounted inside RV 100 or within the framework thereof. In one embodiment, sensor device 132 is mounted to one of the aforementioned sections. In another embodiment, sensor device 132a is mounted to front 104 and sensor device 132b is mounted to side 112. Smart device 136, such as a smart mobile phone or tablet, communicates bi-directionally with sensor device 132 in a variety of ways. For example, sensor device 132 and smart device 136 can communicate through a wired connection. In other embodiments, sensor device 132 and smart device 136 can communicate through wireless communications, such as Bluetooth and cellular. In any case, the combination of senor device 132, smart device 136, as well as jacks 120a-120d, constitute leveling system 140.

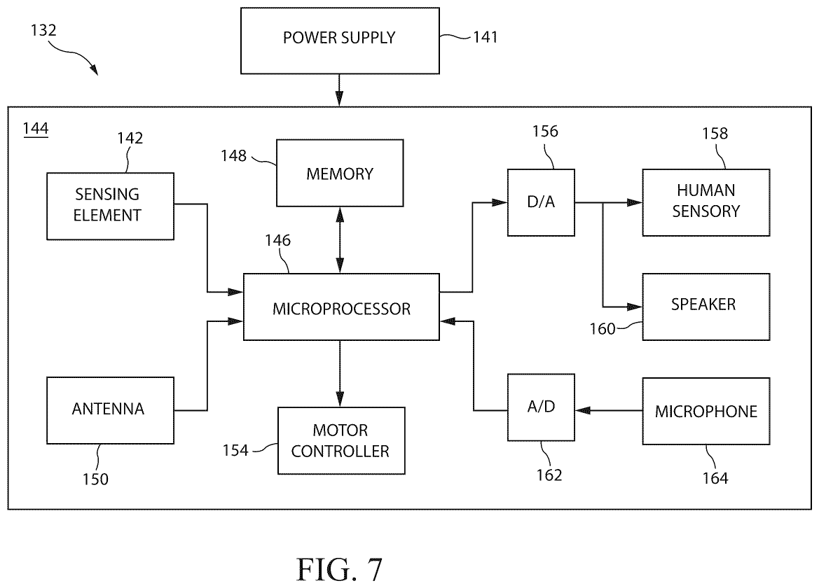

FIG. 7 illustrates further detail of sensor device 132. Sensing element 142 is mechanically and electrically connected to printed circuit board (PCB) 144. Power supply 141 provides electric power to all components of PCB 144. Power supply 141 can be a battery or other DC power source or AC power source. Sensing element 142 can be one or more digital accelerometers, one or more digital gyroscopes, global positioning system (GPS) sensor, and other sensors, axes, for example, an X-axis, a Y-axis, and a Z-axis that are used to determine movement and position, as required for accomplishing the desired position sensing and leveling functionality of RV 100. When installing sensor device 132 or after installation, whether on the front, the rear, sides or at a central location of RV 100, one of the axes of the accelerometer can be assigned to measure the pitch P and another of the axes can be assigned to measure the roll R. The orientation of sensor device 132 relative to the front, the rear, passenger side or drive side upon or after installation can be noted using the software application on either the PCB of sensor device 132 or smart device 136 so that an appropriate axis can be assigned to determine the pitch angle measurement, and an appropriate axis can be assigned to determine the roll angle measurement. The orientation of sensor device 132 can be identified or assigned relative to the vehicle. The mobile smart device 136 software application may have a screen designed to define the installed orientation of sensor device 132 so that data from the appropriate axes can be used for pitch and roll calculations.

Sensor device 132 can have a digital temperature sensor to collect temperature data. The temperature data collected by the digital temperature sensor can be used to correct variations or irregularities in the data obtained by sensor device 132. PCB 144 can then be placed in a stationary position in an environmental chamber. Such an environmental chamber can expose the PCB to a broad range of temperatures, such as typical temperatures during use. The environmental chamber can be a freezer that exposes the PCB therein to low temperatures. One reason such an action is done is to determine variances in, for example, the measurements obtained from the gyroscope or accelerometer included in the respective PCB. Since the PCB is in a stationary position when placed in these environmental chambers, the accelerometer data or gyroscope data should not change but, for example, the accelerometer data or gyroscope data does due to temperature change. The changes in such can be monitored by the firmware on PCB to determine how to Compensate for the discrepancy in the accelerometer data or gyroscope data to maintain the level of accuracy of the data readings at different temperatures.

For PCBs that include accelerometers, each PCB is soldered slightly differently, and each accelerometer is manufactured with slight differences. For such reasons, each PCB can undergo a temperature calibration process to achieve more accuracy and repeatability. During the calibration process while the PCB is held in a stationary position, the firmware monitors the accelerometer data. When the firmware detects a change in the accelerometer data, a temperature sensor on the PCB is read by the firmware and the accelerometer count (angle) deviation that has occurred is recorded along with the temperature in a temperature calibration lookup table by the firmware. After the PCB has been subjected to a range of temperatures and the firmware has recorded all the accelerometer count (angle) deviation in the temperature calibration lookup table, the temperature calibration process is complete. The resulting temperature calibration lookup table can be used each time accelerometer data is used for calculations in the regular use of the sensor device, i.e., the vehicle leveling device, and the vehicle leveling system. So, when the vehicle leveling system is in use, accelerometer data is read along with the current temperature from the sensor device. The firmware on the PCB then looks up that temperature in the temperature calibration lookup table. Any angle deviation at that temperature in the temperature calibration lookup table is read and used to correct the current accelerometer angle data. The temperature corrected accelerometer data is then used to calculate the height requirements needed to level the vehicle for that reading. As stated above, a similar temperature calibration process can be performed for gyroscopes to create a temperature calibration lookup table for gyroscope data.

Sensing element 142 is capable of monitoring multiple axis of orientation, for example, an X-axis, a Y-axis, and a Z-axis that are used to determine movement and position of RV 100 and other leveling data. For the present explanation, the X-axis of sensor device 132 is the pitch, the Y-axis of the sensor device is the roll, and the Z-axis of the sensor device is the vertical alignment of RV 100. The orientation of sensor device 132 relative to the front, the rear, passenger side or drive side upon or after installation can be noted using the software application on either PCB 144 of sensor device 132 or smart device 136 so that an appropriate axis can be assigned to determine the pitch angle measurement, and an appropriate axis can be assigned to determine the roll angle measurement. The orientation of sensor device 132 can be identified or assigned relative to the vehicle. The mobile smart device 136 software application may have a screen designed to define the installed orientation of sensor device 132 so that data from the appropriate axes can be used for pitch and roll calculations.

Microprocessor 146 is mechanically and electrically connected to PCB 144 and sends and receives electrical signals with respect to sensing element 142. Memory 148 is mechanically and electrically connected to PCB 144 and sends and receives electrical signals with respect to microprocessor 146. Microprocessor 146 reads and writes to memory 148 and/or applications on the edge or cloud base. Antenna 150 is mechanically and electrically connected to PCB 144 and sends and receives electrical signals with respect to sensor element 142 and microprocessor 146. Antenna 150 can process Bluetooth, cellular, WiFi, or other wireless communications. Smart device 136 includes software that is capable of communicating with PCB 144 of sensor device 132, storing information obtained from the PCB of sensor device 132, manipulating the information obtained from the PCB of sensor device 132 and/or user input related to the inclination and/or orientation of RV 100, control of jacks 120a-120d, and displaying of information obtained from the PCB of sensor device 132 and user input, as well as information generated from the information obtained from the PCB of sensor device 132 and/or the user input related to the inclination and/or orientation of RV 100. PCB 144 and RV 100 can operate with other types of sensors.

Motor controller 154 is mechanically and electrically connected to PCB 144 and sends and receives electrical signals with respect to microprocessor 146 to control motor 130 for jacks 120a-120d. Digital-to-analog (D/A) converter 156 is mechanically and electrically connected to PCB 144 and sends and receives electrical signals with respect to microprocessor 146 to control human sensory output 158 and speaker 160. Analog-to-digital (A/D) converter 162 is mechanically and electrically connected to PCB 144 and sends and receives electrical signals with respect to microprocessor 146 to control microphone 164.

Microprocessor 146 contains software and firmware to allow for the processing of data and performing calculations related to the desired functionality of the RV leveling system. Sensor device 132 can be battery powered or use other means of power, such as AC or DC connections. Sensor device 132 is typically contained within a housing or enclosure for environmental protection and isolation from other damage.

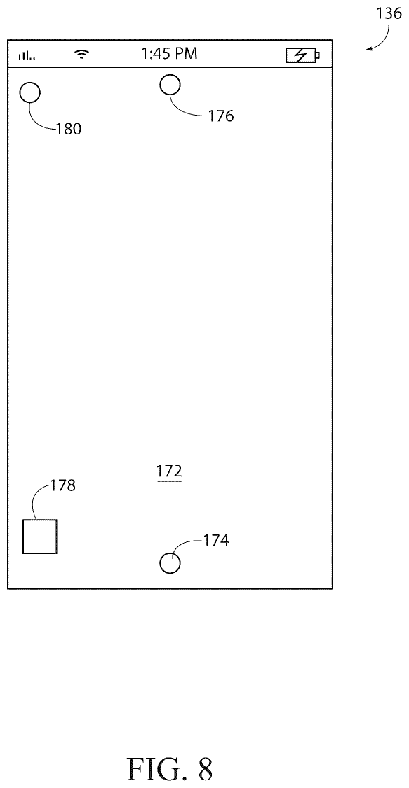

FIG. 8 illustrates smart device 136, such as a smart mobile phone or tablet, with display and touch screen 172 to communicate with and otherwise interact with sensor device 132 via graphical and audible commands. Smart device 136 has microphone 174 for the user to provide audible commands and feedback and speaker 176 for the user to hear audible commands and feedback. Smart device 136 also has vibrator 178 for the user to receive haptic commands and feedback and light source 180 for the user to observe sensory commands and feedback. Smart device 136 communicates with sensor device 132 by sending and receiving signals through antenna 150.

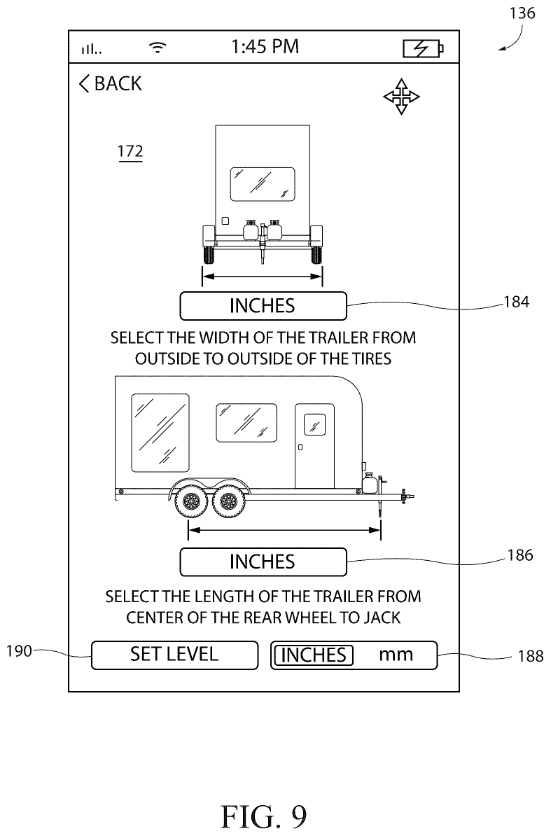

Smart device 136 provides a number of user interface screens to provide input to sensor device 132 and receive feedback from the sensor device. The user controls and interacts with sensor device 132 through software applications on smart device 136. For example, the software application on smart device 136 can prompt the user to enter information such as the measurements of RV 100, e.g., the length and width of RV 100, that can be used during calibration. In FIG. 9, button 184 on display and touch screen 172 allows the user to enter a width of RV 100 as measured from the outside of a first wheel, or tire, on a first side of the RV to the outside of a second wheel, or tire, on a second side of the RV along an axle of the RV. Button 186 allows the user to enter a length of RV 100 as measured from back 102 to front 104, or from a center point of the rear axle to RV tongue 107. Button 188 allows the user to select between imperial or metric measurements.

An initial level position can be determined for RV 100 to help determine any inconsistencies inherent in the leveling system, such as inconsistencies due to the installation or placement of the sensor device on the RV that may cause the sensor readings to be slightly off. Smart device 136 can be used to determine the initial level position using the accelerometer, gyroscope and/or GPS functions therein through a portion of the software application, or a different software application, as shown in FIG. 7 and described in more detail below. Assume RV 100 is positioned on a known level surface. A typical digital or spirit level can also be used to confirm the initial known level position. Smart device 136 can then capture, i.e., save and store the current pitch and roll angle measurements from sensor device 132 by accelerometer, gyroscope and/or GPS functions therein. These measurements will be used as offsets from the initial level position when displaying angles or calculating and displaying adjustment values necessary to move the RV back to the initial level position. The software application can determine if the measurements from sensor device 132 are slightly off when the RV is at the initial level position and then take those inconsistencies into consideration when taking measurement readings in the future.

In particular, the software application on smart device 136 can have a calibration function as represented by “Set Level” button 190 in screen 172 for the initial set up of the software application. The “Set Level” button 190 can be used to obtain the current sensor readings in the roll and pitch directions from sensor device 132 when smart device 136 indicates that the vehicle is in a known level position. These sensor readings, when RV 100 is at the initial position, may be stored as calibration data on smart device 136 or sensor device 132 or both. The calibration data can be used to compensate for any imperfections in the sensor readings that may derive from the installation and/or placement of sensor device 132 on RV 100. Once the calibration function is completed, it does not necessarily need to be performed again. Button 190 allows the user to save the measurements upon transfer of the information from smart device 136 through antenna 150 to memory 148. The above RV information is provided by way of example. It is understood that other specific and useful RV information can be input through smart device 136.

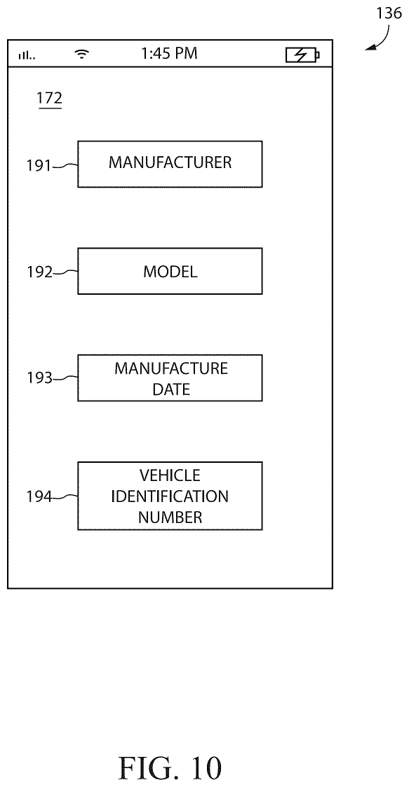

In another example, the software application on smart device 136 can prompt the user to enter information about RV 100, e.g., manufacturer, model, and manufacture date, that can be used during calibration. In FIG. 10, button 191 on display and touch screen 172 allows the user to enter the RV manufacturer. Button 192 allows the user to enter the RV model. Button 193 allows the user to enter manufacture date. Button 194 allows the user to enter the vehicle identification number. Smart device 136 software applications can display lists of various makes and models of RV 100, including pictures and other information, or read a QR code permanently attached to the RV to fill in all necessary information. The makes and models of RVs can be available by internet search. The screen can allow the user to scroll the list or can provide a search mechanism that allows the user to find the specific RV in question or shorten the list of RVs to be viewed. In this manner, the user would simply select the make and model of the RV from a list contained within the mobile smart device software application of smart device 136. In some embodiments, the length and width measurements in FIG. 10 could be pre-programmed for various makes and models of RVs.

Leveling system 140, with communication between sensor device 132 and smart device 136, as well as jacks 120a-120d, provide a system to level RV 100. Smart device 136 can have a specific software application thereon that allows information received from sensor device 132 about the inclination and/or orientation of RV 100 to be processed to provide measurements to a user and to determine the number of adjustments needed to level RV 100. To accomplish the adjustments so that, upon parking RV 100, the RV will be leveled in both the pitch and roll directions, leveling system 140 provides measurements to determine the amount of adjustment needed in both the pitch and roll directions.

Smart device 136 can comprise software that is capable of communicating with PCB 144 of sensor device 132, storing information obtained from the PCB of sensor device 132, manipulating the information obtained from the PCB of sensor device 132 and/or user input related to the inclination and/or orientation of RV 100, and displaying of information obtained from the PCB of sensor device 132 and user input as well as information generated from the information obtained from the PCB of sensor device 132 and/or the user input related to the inclination and/or orientation of RV 100. In some embodiments, sensor device 132 can comprise memory 148 in communication with microprocessor 146 and can be used to store information transmitted from mobile smart device 136. Sensor device 132 can use sensor data and/or stored user data to perform calculations on sensor device 132 and transmit the calculated data to mobile smart device 136 for further calculation or display or both. In Some embodiments, smart device 136 can be a smartphone capable of storing and executing software applications. These calculations can be based off of the determination of the pitch and roll angles using the calibration data to determine the pitch angle measurements and the roll angle measurements. These calculations can include geometric calculations that can convert changes in angles to distance of movement needed to obtain a level position of the vehicle in both the roll direction and the pitch direction based on the length and width of the vehicle being leveled, Such geometric calculations can be based on Common geometric formulas that would be understood by those skilled in the art.

The software application can be used to determine the change in roll and the change in pitch needed for the given RV 100 based on measurements from sensor device 132 at any given location. Typically, accelerometer data, even though digitally filtered, can be choppy and cause the display of the calculated height to change between the set filter levels, i.e., the display resolution, for the digital filter that are to be displayed based on the calculations. In some situations, when the display resolution is set to smaller increments, for example, of 0.6 cm, the display of the expected height change can move back and forth between the closest two increments or flicker back and forth between the increments. The display of the calculated height can flicker between 0.0 cm and 0.6 cm if the native resolution of the digital filter within the sensor device or vehicle leveling device, is 0.6 cm and the calculated height is a measurement between 0.0 cm and 0.6 cm.

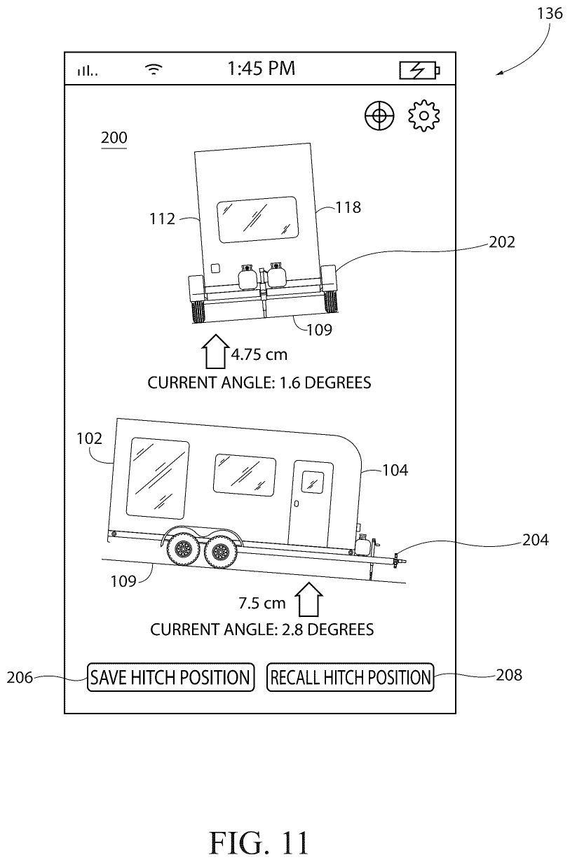

FIG. 11 shows a display on smart device 136 with RV 100 in an unlevel state in roll display 202, leaning toward side 112 in a front view, and further with RV 100 in an unlevel state in pitch display 204, leaning toward front 104 in a side view. In this case, the change in roll to achieve a level position is determined by the application software to be 4.75 centimeters (cm) upward on side 112. The change in pitch to achieve a level position is determined by the application software to be 7.5 cm upward on front 104. Alternatively, the change in roll can be shown as 1.6 degrees, and the change in pitch can be shown as 2.8 degrees. Roll display 202 can provide the current angle from level for the roll directions measured in degrees and the amount of elevation change in inches or cm needed on a given side to level the RV in the roll direction. Pitch display 204 can provide the current angle from level for the pitch directions measured in degrees and the amount of elevation change in inches or cm needed on a given side to level the RV in the pitch direction.

Typically, RV users use jacks 120a-120d or plastic blocks or wooden dimensional lumber as adjustment blocks to drive RV 100 up to get to the height required to reach a level position. Jacks 120a-120d are adjustable to the resolution of the mechanism. Adjustment blocks are of a regular thickness, for example, are all 2.5 cm thick then the accuracy of getting to a level position is going to be determined based on the set block thickness, meaning that the change in elevation of height will be in 2.5 cm increments. The software application can include a screen that will allow the input of an increment of resolution by which the digital filter will operate for providing an adjustment of height in the elevation run direction and the pitch direction. If the RV users have 2.5 cm blocks, in some embodiments, the user can provide a display resolution that can be selected from a menu of a variety of different display resolutions that can match the height of adjustment provided by the adjustment blocks the RV user may have. In some embodiments, the software application can provide a screen in which the RV user can enter the increment of display resolution for the leveling system to use. The leveling system and methods provided herein can provide the ability of the RV user to select different display resolutions. Thus, as explained in the example above, the RV user can select the display resolution of 0.1 cm and the smart device running the software application would only show calculated heights in 0.1 cm increments. By increasing the value of the display resolution, the RV user can obtain more useful information for obtaining the adjustment in height that they need, and the display based on the larger increment of the display resolution can be much more stable and less likely to flicker between incremental numbers due to the wider threshold of rounding in the math. The display resolution can be set during a configuration or installation of the sensor device.

As the current roll angle changes, the roll angle measurements expressed in degrees and/or the amount of elevation change will change. As the current pitch angle changes, the pitch angle measurements expressed in degrees and/or the amount of elevational change will also change. More particularly, for example, for the change in pitch, the amount of elevation change can be affected by the moving of jacks 120a-120d proximal to the front 104 up or down by the requisite distance displayed. The changes in current roll and pitch angles can also be shown in the graphic image of the vehicle as shown in displays 202 and 204 in real time or near real time. Leveling is often an iterative process.

As shown in the screen 200 in FIG. 11, the mobile smart device software application can also provide the ability to save a given pitch angle, either on smart device 136 or on sensor device 132, for the purpose of returning to that position at a later time, as illustrated by the “save hitch position” button 206 in screen 200. To reuse the pitch angle that had been saved, a recall can be provided, such as recall button 208. This functionality can be useful for travel trailers and fifth wheel RVs that must be detached from a tow vehicle when in use. The pitch angle saved when the tow vehicle is detached from the RV will be recalled for pitch angle positioning when reattaching the tow vehicle to simplify and increase the speed of reattaching the tow vehicle to RV 100.

Sensor device 132 may use the calibration data as well as other current sensor data, such as the current pitch angle and roll angle measurements and temperature readings from sensor device 132 or another temperature sensor device, and perform calculations, such as an accurate calculation of the current angle of the vehicle and the offset that is needed, using the processor and firmware on the PCB of sensor device 132. The user can activate the software application to initiate the measurements to determine the change in roll and pitch by simply opening the software application on smart device 136 when connected to a wire communication with sensor device 132 or within range of sensor device 132 for a wireless communication connection, depending on how communication is setup between smart device 136 and sensor device 132. The software application can display an interface on a display screen, such as a button, once the software application is opened that can be activated to initiate this determination, or calculation, function. The user can also initiate the software application by audible or other human sensory feedback.

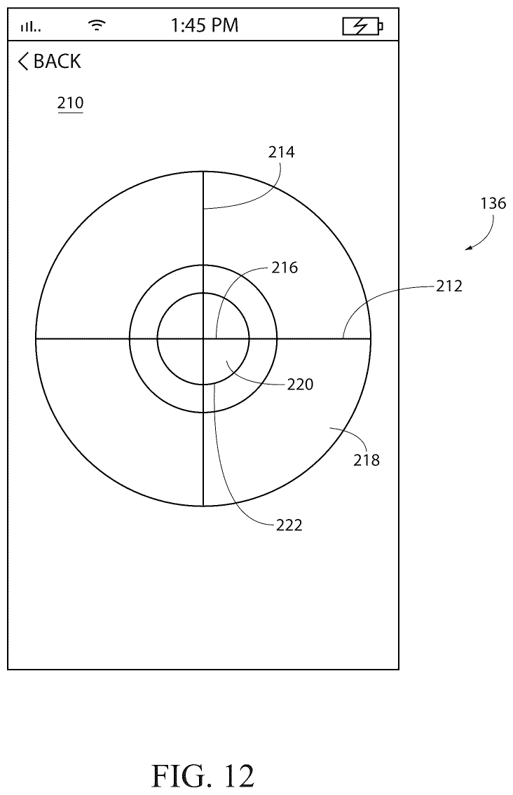

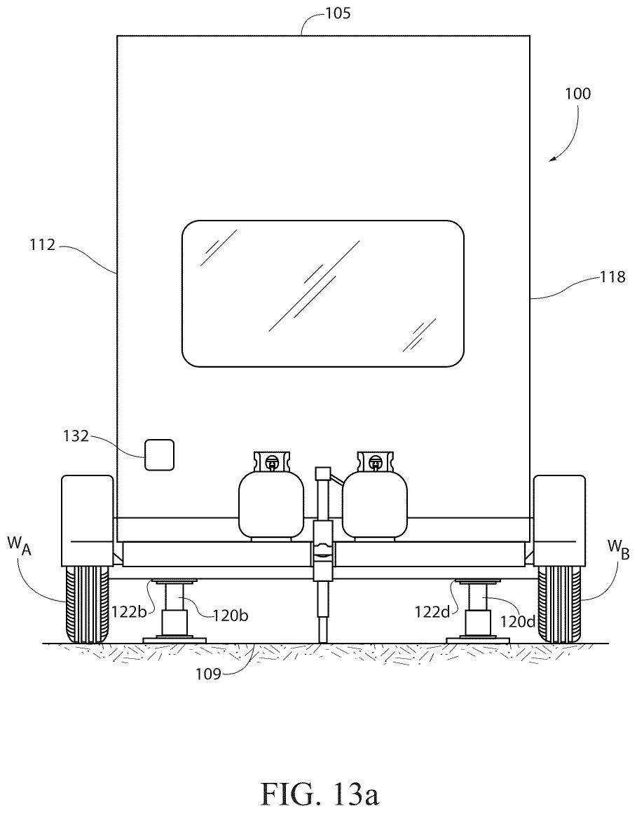

As mentioned above and described in more detail below, in some embodiments, once sensor device 132 has been properly mounted to the inside or outside of RV 100, the RV can be leveled to an initial level position using the typical method described above or by placing smart device 136 on the floor or some other horizontal surface of the RV and using a digital level software application, either separate from or integrated into the software application. FIG. 12 shows a screen 210, for example, of the software application that can be used to measure both the pitch and the roll angles using pitch measuring line 212 and roll measuring line 214 forming crosshair 216. The software application on smart device 136 can show a display that operates in a similar manner to a spirit level so as to display movement of the pitch and roll angles toward a center bull's eye 220 as the smart device on the horizontal surface is moved toward a leveled position. The progress toward the bull's eye 220 can be measured by the position of crosshair 216 relative to area 218 surrounding bull's eye 220 as crosshair 216 approaches the demarcation line 222 as the horizontal surface is moved closer to the leveled position. In this manner, smart device 136 can be used in the initial leveling to determine an initial level position. As mentioned above, a typical digital or spirit level could also be used to achieve the initial level position. Smart device 136 can then capture, i.e., save and store the current pitch and roll angle measurements from sensor device 132 or cause (by a transmitted instruction from smart device 136) sensor device 132 to save and store the calibration data of pitch and roll angle measurements on sensor device 132. The calibration data will be used as offsets from the initial level position when displaying angles or calculating and displaying adjustment values necessary to move RV 100 back to the initial level position.

Once measurements are generated using set level button 190 that relate to the initial level position of RV 100, these measurements can be stored on smart device 136 or stored in a memory storage location on the PCB sensor device 132 and recalled to smart device 136 at a desired time. Smart device 136 with the software application running can then be used to calculate and display angles relative to the initial level position and to calculate and display adjustment values necessary to move RV 100 to the initial level position when the RV is moved to a location for use. In some embodiments, the calculation of angles relative to the initial level position can be performed by the processor and firmware on the PCB of sensor device 132. Performing the calibration function on the software application, smart device 136 can wirelessly connect (or, in some embodiments, connect through a wired connection) to sensor device 132 and request the current angle measurements for pitch and roll. These measurements can be stored on smart device 136 or stored in memory 148 on sensor device 132 and recalled to smart device 136 at a desired time, for use in calculating displayed information in the subsequent screens such as screen 200 shown in FIG. 11 with roll display 202 and pitch display 204, as explained below, The stored measurements can be used as offsets from the initial level position based on the angle indications calculated from the various sensors of sensor device 132 to establish a relationship between the position of the mounted sensor device 132 and the initial level position in both pitch and roll as measured and/or captured by smart device 136 or sensor device 132, as described above.

In subsequent displays 202, 204 of the current angles relative to the initial level position on the software application on smart device 136 as shown in screen 200 in FIG. 11, for example, these stored calibration data measurements will be added to or subtracted from the actual calculated sensor data from the PCB of sensor device 132 to determine the actual angle relative to the initial level position accounting for the actual mounted orientation of sensor device 132. Sensor device 132 can be mounted with any orientation and calibrated to absolute level, Displays 202, 204 can show an image of the vehicle that reflects the actual position of RV 100 with the actual angles in the respective pitch and roll directions of the RV such that the image of the vehicle moves as the angles in the respective pitch and roll directions of the RV change. Once accurate angle measurements have been calculated and displayed in screen 200 of the software application on smart device 136, additional calculations regarding the added height needed to achieve the initial level position of the RV can be performed either by the software application of the mobile smart device 136 or by the processor and firmware on the PCB of sensor device 132. The calculations regarding the added height needed to achieve the initial level position of RV 100 can be displayed by the software application on mobile smart device 136, for example, in the respective roll display 202 and pitch display 204 or on a different screen in other embodiments. The appropriate side or direction of added or removed height can also be displayed using arrows and/or the calculated height required as shown for example in the respective roll display 202 and pitch display 204 of screen 200 of the described example embodiment of software application. The calculations are achieved by using the stored information about the length and width of RV 100 and the calculated current angle relative to the initial level position of the RV and using trigonometric formulas to calculate the height and location for the height addition or reduction to achieve a level position.

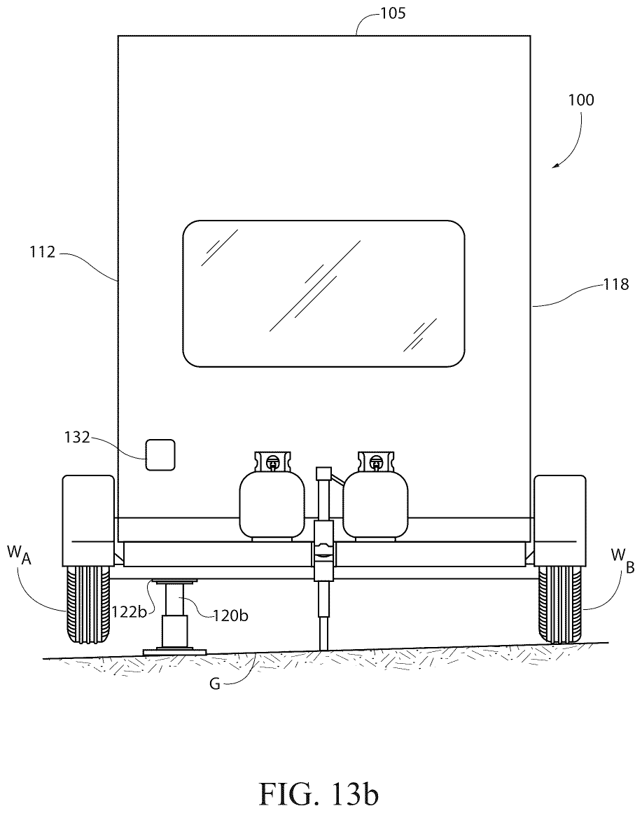

FIGS. 13a-13b illustrate an example of leveling RV 100 on unlevel ground 109. Sensor device 132 measures the current conditions and state of levelness. FIG. 13a shows RV 100 positioned on unlevel ground 109. Sensor device 132 or smart device 136 then calculates the change needed to achieve a level position. The change can be calculated as the difference between the present state and the calibrated known level state. Once leveling system 140 has calculated the change of elevation height needed in the roll direction and the pitch direction, the smart device can determine how much each jack needs to be raised to level RV 100. The software application can display on the smart device, similar to FIG. 11, or provide by audible or other human sensory feedback in accordance with FIG. 7, the height required to reach a level position for each jack 120a-120d.

Display screens 200 and 210 in FIGS. 11 and 12 can be considered one embodiment of receiving leveling feedback. The software application on smart device 136 can also provide audible or other human sensory feedback. FIG. 7 illustrates PCB 144 in sensor device 132 capable of providing the audible or other human sensory feedback. In one embodiment, based on the leveling data from sensor device 132, microprocessor 146 generates a series of beeps or other audible tone from speaker 160. The audible tones can originate from sensor device 132 or smart device 136. The audible tone originates from an audible table stored in memory 148. The audible tone is routed through D/A converter 156 to speaker 160 for audible transmission to the user. The base frequency tone of the audible tone is selectable. The frequency of the audible tone increases or decreases with the nature of the feedback. For example, the audible tone will have a slower frequency, say 1 tone per second, when RV 100 is well off-level, and move to higher frequency, say 5-20 tones per second, as the RV approaches a level state. The progression in frequency can be linear with the movement towards a level state. Light source 180 can adjust color and blink rate, just as the various tones from speaker 160 or speaker 176, to provide human sensory feedback. Jacks 120a-120d are adjusted, manually or automatically, in response to audible or other human sensory feedback to zero out the difference angles and level RV 100.

In another type of audible feedback, the software application on smart device 136 can provide voice feedback. For example, the software application on smart device 136 can provide various computer-generated words or phrases to be broadcast from speaker 160 or speaker 176. The computer-generated words or phrases would be indicative of the nature of the feedback. For example, the computer-generated words from speaker 160 or speaker 176 may say “you are 1 cm high to the right front of the RV, lower the right front by 1 cm.” The computer-generated words may say “you are 2 cm low to the left rear of the RV, raise the left rear by 2 cm.” The computer-generated words may say “pause and place 2 cm support under the left front tire or jack.” The computer-generated words provide directions and recommendations to most efficiently level RV 100. The directions and recommendations would be based on the leveling data from sensor device 132, as well as calculations within microprocessor 146 including direction and distance to zero out the difference angles, to determine what should be the next physical step the user should undertake to level RV 100 as efficiently as possible. The software tells the user what needs to be done and where the action needs to occur to properly level the RV. The software operates as a real-time leveling coach or advisor to assist the user. Jacks 120a-120d are adjusted, manually or automatically, in response to audible or other human sensory feedback to zero out the difference angles and level RV 100. Memory 148 includes a voice table of predetermined words or phrases for microprocessor 146 to select from, based on the indicated action. D/A converter 156 converts the digital information to analog signal for speaker 160.

Smart device 136 can also provide human sensory feedback 158, such as light or haptic feedback, through D/A converter 156. The user can observe light from light source 180 in smart device 136 or feel vibrations, taps, or pulses from vibrator 178 in the smart device as human sensory feedback. When providing human sensory feedback, an icon can be displayed on the smart device screen. For example, audible feedback can be an ear icon.

Microprocessor 146 can also receive feedback from the user through microphone 174. The user may provide relevant information to microprocessor 146, such as “it is raining and the RV and jacks are resting on soft ground”, or “the RV appears to be too high in the front”, or “the ground has a 5-degree slope front to back”, or “pause leveling process” or “ready to continue.” The user can ask questions or make statements to microprocessor 146, such as “can you repeat the last instruction”, or “how is the left front”, or “what do I need to do next”, or “let's restart leveling sequence.” The software will interpret and convert the user's words using voice recognition into corresponding digital communication. The directions and recommendations would be based on the leveling data from sensor device 132, as well as calculations within microprocessor 146 including direction and distance to zero out the difference angles, to determine what should be the next physical step the user should undertake to level RV 100 as efficiently as possible. Jacks 120a-120d are adjusted, manually or automatically, in response to audible or other human sensory feedback to zero out the difference angles and level RV 100. Given the iterative nature of RV leveling, the audible or other human sensory feedback makes the process efficient and less stressful. The above described audible and human sensory feedback is referred to as “audible or other human sensory feedback in accordance with FIG. 7.”

The software application on smart device 136 is capable of processing artificial intelligence (AI) to enhance the communication between the user and leveling system. The AI is two-way or interactive in that the software can provide audible or human sensory feedback to the user, and the user can provide communication to the software.

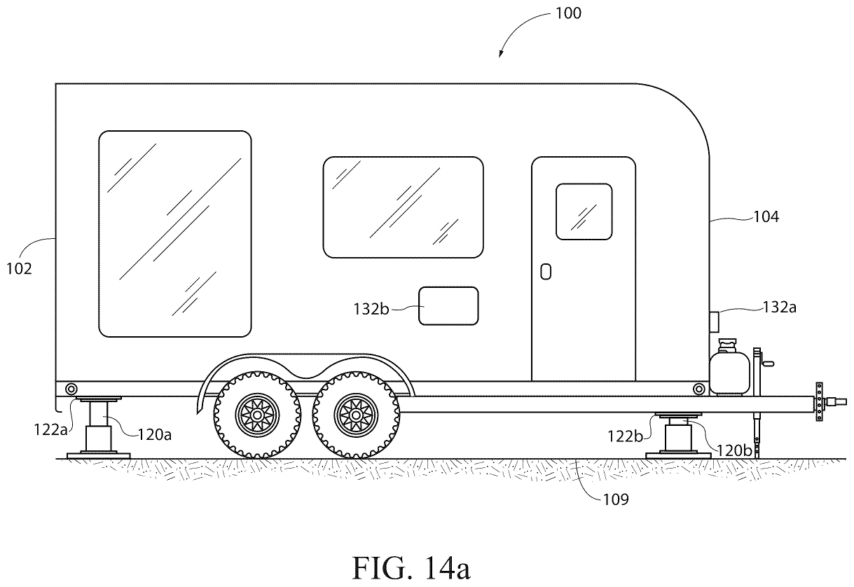

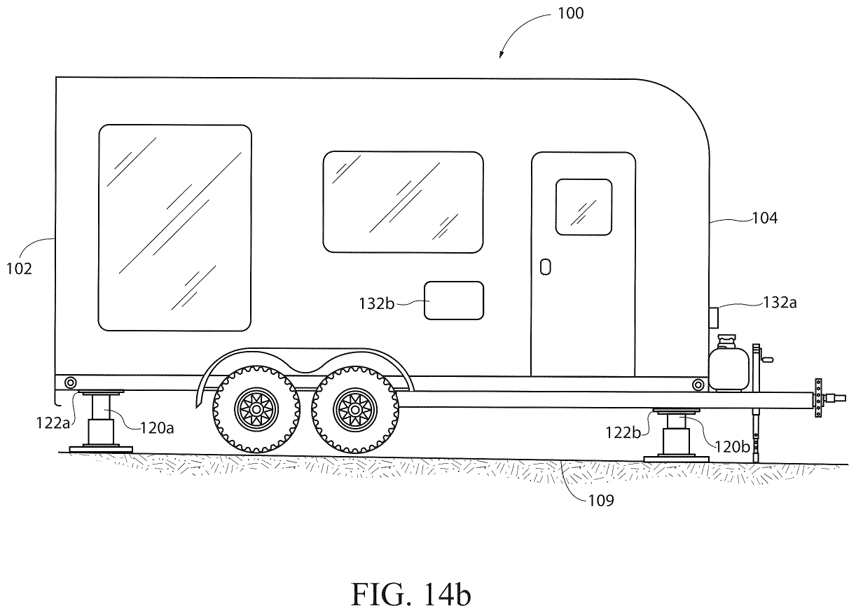

In an example operation, RV 100 can be parked, or positioned, at a desired location, as in FIGS. 13a and 14a. A leveling system 140 on RV 100 (as shown in FIGS. 3 and 4) can be previously used to determine an initial level position that provides a true level measurement that has been stored on smart device 136 of leveling system 140 or stored in a memory storage location on the PCB sensor device 132, such as an RV leveling device, and recalled to smart device 136, for later use. RV 100 can have three or more structural supports, such as wheels W_{A}, W_{B}, and jacks 120a-120d on ground 109 at the desired location. As shown in FIG. 13a, RV 100 leans toward the first side 112 of RV 100. Similarly, as shown in FIG. 14a, RV 100 leans toward front 104 at the desired location, Thus, RV 100 is not leveled at the desired location based on the structural supports current position on ground 109.

The software application on smart device 136 of the leveling system can be accessed to initiate the determination of the needed change in the roll and pitch directions to level RV 100 at the desired location, Smart device 136 can communicate with sensor device 132 of leveling system 140 to obtain sensor data used to determine the current angle measurements for the roll and pitch directions off from true level, i.e., the initial known level position stored in the smart device. The needed angle change, distance change, and/or direction of change for the roll and pitch directions can be displayed on smart device 136 as shown in roll display 202 and pitch display 204 in screen 200 of the software application or provided by audible or other human sensory feedback in accordance with FIG. 7. As shown in FIG. 13b, side 112 can then be raised the needed amount so that side 112 and side 118 can be level with one another in the roll direction based on the information provided in roll display 202 or provided by audible or other human sensory feedback in accordance with FIG. 7. For example, jack 120a and/or jack 120b, or other mechanism can be used to raise side 112 of RV 100. Similarly, as shown in FIG. 14b, the front 104 of RV 100 can be raised the needed amount so that front 104 and a rear side 102 can be level with one another in the pitch direction based on the information provided in pitch display 204 or provided by audible or other human sensory feedback in accordance with FIG. 7. Jacks 120a-120d can be raised or lowered as needed to achieve levelness of RV 100 and audible or other human sensory feedback makes the process efficient and convenient for the user,

Additionally, sensor device 132 can have sensors that are able to detect relative humidity, temperature and barometric pressure. For example, the PCB of sensor device 132 may have sensors that are able to detect relative humidity, temperature, and barometric pressure. The user may desire to mount sensor device 132 on the exterior or interior of the RV depending on whether they are more interested in measuring the environmental conditions outside or inside the RV. The environmental information will also be wirelessly transmitted to smart device 136 and displayed for the user or provided by audible or other human sensory feedback in accordance with FIG. 7.

In some embodiments as stated above, the mobile smart device software application that can be downloaded and run on smart device 136 can permit input of the RV length and RV width for the purpose of calculating the amount of height needed at the appropriate piece to return the RV to a previously defined level position. In some embodiments, the length and width could be pre-programmed for various makes and models of RVs, eliminating the need for the user to measure and input the length and width dimensions, by the screen or audible or other human sensory feedback in accordance with FIG. 7. Instead, the mobile smart device software application can have a screen that lists the make and model of the RV. In some embodiments, the lists of RVs can contain various information about the different makes and models of RVs including pictures and other information. The makes and models of RVs can be available by internet search. The screen can allow the user to scroll the list or can provide a search mechanism that allows the user to find the exact RV in question or shorten the list of RVs to be viewed. In this manner, the user would simply select the make and model of the RV from a list contained within the mobile smart device software application of smart device 136.

RVs typically have control panels that consist of pushbuttons and/or indicator LEDs and/or LCD displays. These control panels are used to display data about the condition of various RV systems or to activate various RV systems. Typical data displayed by some RV control panels can include holding tank fluid levels and battery power levels. Typical RV systems that might be activated from some control panels would be power slideouts and starting or stopping the generator. In some embodiments, smart device 136 can be integrated or in communication with the various RV control panels and systems either through wired or wireless communications. For example, utilizing a wireless communication system or protocol, such as Bluetooth, WiFi, and cellular, the mobile smart device software application on smart device 136 can display the data that is generated and displayed on some of the RV control panels such as holding tank levels, battery power levels and the like. In addition, the mobile smart device software application can also be used to activate various RV systems such as power slideouts, starting the generator, stopping the generator, or the like. The mobile smart device software application could also be used to control more general RV systems such as lighting and entertainment systems. For example, the mobile smart device software application can generate screens that are displayed on smart device 136 that display the data that is generated and displayed on some of the RV control panels. Additionally, the mobile smart device software application can generate screens that are displayed on smart device 136 that provide user interfaces, such as buttons that can be used to activate various RV systems by the user, for example, remotely or wirelessly. All of the above control and feedback can be done with audible or other human sensory feedback using FIG. 7. The audible or other human sensory feedback can advise when to deploy the slideouts, and in which order, during the leveling process.

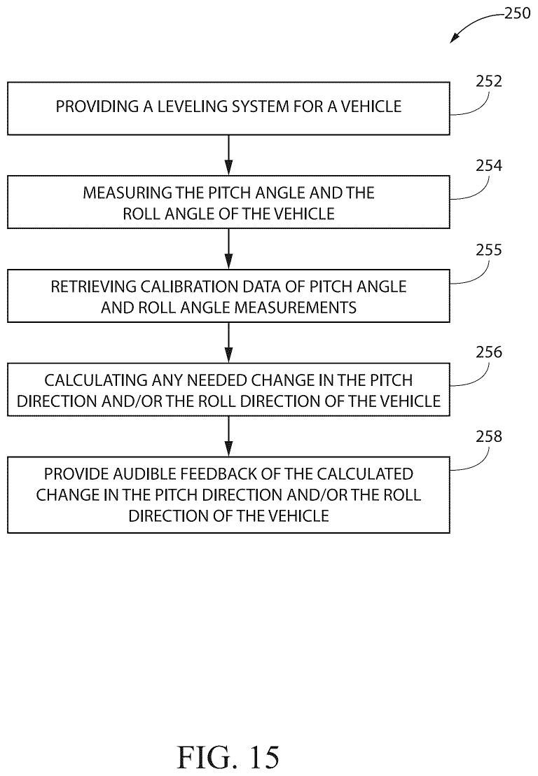

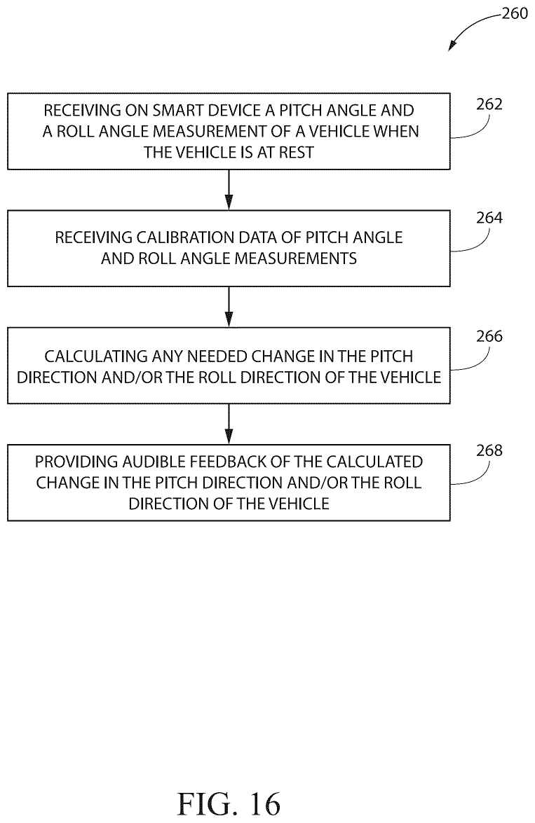

Thus, a software application in the form of a non-transitory computer readable medium can be provided that comprises computer executable instructions embodied in a Computer readable medium that when executed by a processor of a computer control the computer performs the steps similar to the method, generally designated 250, for leveling a vehicle, such as a recreational vehicle, can be provided as shown in FIG. 15. To begin, a leveling system can be provided that comprises one or more sensor devices, that can comprise one or more vehicle leveling devices secured to a vehicle to sense at least one of an inclination or an orientation of the vehicle in both a pitch direction and a roll direction and a smart device in communication with the one or more sensor devices, as shown in step 252. The non-transitory computer readable medium can perform a step 254 of measuring the pitch angle and the roll angle of the vehicle when the vehicle is at rest using the sensor device. To determine the needed movement of the vehicle to achieve a level position based on the measures of the pitch angle and the roll angle, calibration data of pitch angle and roll angle measurements taken by the sensor device when the vehicle was at an initial level position can then be retrieved, as shown in step 255. The non-transitory computer readable medium can perform a step 256 of calculating any needed change in at least one of the pitch direction or the roll direction of the vehicle using the measurements of the pitch angle and the roll angle of the at rest vehicle and the calibration data of pitch and roll angle measurements to obtain a level position of the vehicle. The calculation can be performed by the one or more sensor devices or the smart device. The non-transitory computer readable medium can perform a step 258 of calculating a change in at least one of the pitch direction or the roll direction of the vehicle can be provided by audible or other human sensory feedback in accordance with FIG. 7 or displayed on the smart device.

In order to initially develop the calculation data, the method described above can also include the step 255 of determining the initial level position for a vehicle to determine any inconsistencies inherent in the leveling system. Depending on the embodiment of the method, the determination step can be performed on the one or more sensor devices or the smart device. The step 255 of determining an initial known level position can comprise receiving measurements of a length and a width of the vehicle. The step 255 of determining an initial level position can comprise using at least one of an accelerometer, gyroscope, or global positioning system sensor on the smart device to achieve the initial level position. The step 255 of determining an initial level position can comprise using at least one of a digital level or spirit level can also be used to achieve the initial level position. The step 255 of determining an initial known level position can be performed during manufacture of the vehicle on a known level surface and the calibration data stored on the sensor device installed during manufacture. When installing the sensor device or after installation, whether on the front, the rear, sides or at a central location of the vehicle, an axis of a plurality of axes of the accelerometer on the sensor device can be assigned to measure the pitch of the vehicle and another axis of the plurality axes of the accelerometer on the sensor device can be assigned to measure the roll of the vehicle. For instance, the orientation of the sensor device relative to the front, the rear, the passenger side or the drive side of the vehicle can be noted using the software application on either the sensor device or the smart device so that an appropriate axis can be assigned to determine the pitch angle measurement of the vehicle and an appropriate axis can be assigned to determine the roll angle measurement of the vehicle. The mobile smart device software application may have a screen designed to define the installed orientation of the sensor device so that data from the appropriate axes can be used for pitch and roll calculations. The pitch and roll angle measurements from the sensor device taken at the initial level position can then be captured, i.e., identified and stored or saved, to provide the calibration data of the pitch and roll angle measurements to permit consideration of any inconsistencies determined when taking measurement readings at a future time. For example, the calibration can be calculated and then saved on a sensor processor on the one or more sensor devices or saved on the smart device that is in communication with the one or more sensor devices. The step 254 of measuring or capturing the pitch and roll angle measurements from the sensor device can comprise communicating calibration data from the sensor device of the pitch and roll angle measurements measured by the sensor device when the vehicle is at the initial level position to the smart device and saving the calibration data on the smart device. The step 254 of capturing the pitch and roll angle measurements from the sensor device can comprise saving the calibration data of the pitch and roll angle measurements measured by the sensor device when the vehicle is at the initial level position on the sensor device. In some such embodiments where the calibration data is saved on the sensor device, the step of saving the calibration data of the pitch and roll angle measurements on the sensor device can comprise transmitting instructions from the smart device to the sensor device to save and store the calibration data of the pitch and roll angle measurements on the sensor device. In some such embodiments, the method can include recalling the calibration data of the pitch and roll angle measurements from the sensor device to the smart device.

In some embodiments of the method, the step 258 of providing audible or other human sensory feedback in accordance with FIG. 7 or displaying the calculated change in at least one of the pitch direction or the roll direction of the vehicle can comprise providing audible or other human sensory feedback or displaying the calculated change in the pitch direction and the roll direction of the vehicle in measurements of distance. The step 258 of providing audible or other human sensory feedback or displaying the calculated change in at least one of the pitch direction or the roll direction of the vehicle can compose providing audible or other human sensory feedback or displaying the calculated change in the pitch direction and the roll direction of the vehicle as angles.

In some embodiments, the method can additionally comprise providing a conversion function to permit the changing of the system used for measurements between U.S. Customary System and the Metric System. The method can additionally comprise saving a given pitch angle measurement on at least one of the smart devices or the sensor devices to permit later recall for the purpose of returning the vehicle to the given pitch angle position at a later time. The method can further comprise collecting and storing positional movement information of the vehicle using a global positioning system sensor on the sensor device.

In some embodiments, the method can additionally comprise receiving data at the smart device from one or more vehicle control panels. The received data from one or more vehicle control panels can comprise at least one of data regarding holding tank levels or data regarding battery power levels. The smart device can provide audible or other human sensory feedback in accordance with FIG. 7 or display the data that is generated and displayed on the one or more vehicle control panels.

As stated above, a software application in the form of a non-transitory computer readable medium can be provided that comprises computer executable instructions embodied in a computer readable medium that when executed by a processor of a computer control the computer performs the steps similar to the method, generally designated 260, described above. For example, as shown in FIG, 16, the non-transitory computer readable medium can perform a step 262 of receiving on a smart device a pitch angle measurement and a roll angle measurement of a vehicle when the vehicle is at rest from a sensor device. Additionally, the non-transitory computer readable medium can perform a step 264 of retrieving calibration data of pitch angle and roll angle measurements taken by a sensor device when the vehicle was at an initial level position. The sensor device can comprise a vehicle leveling device or an RV leveling device. The non-transitory computer readable medium can also perform a step 266 of calculating any needed change in at least one of a pitch direction or a roll direction of the vehicle using the calibration data of the pitch and roll angle measurements to obtain a level position of the vehicle. The non-transitory computer readable medium can further perform a step 268 of providing audible or other human sensory feedback in accordance with FIG. 7 or displaying on the smart device the calculated change in at least one of the pitch direction or the roll direction of the vehicle needed to obtain the level position of the vehicle.

In order to initially develop the calculation data, the method performed by the software application described above can also include the step of determining the initial level position for a vehicle to determine any inconsistencies inherent in the leveling system. The step of determining an initial level position can comprise receiving measurements of a length and a width of the vehicle. The step of determining an initial level position can comprise using at least one of an accelerometer gyroscope, or global positioning system sensor on the smart device to achieve the initial level position. The step of determining an initial level position can be performed during manufacture of the vehicle and the calibration data stored on the sensor device installed during manufacture.

The software application can then be used to capture, i.e., identified and stored or saved, pitch and roll angle measurements from the sensor device taken at the initial level position to provide the calibration data of the pitch and roll angle measurements to permit consideration of any inconsistencies determined when taking measurement readings at a future time. For example, the calibration can be calculated and then saved on a sensor processor on the one or more sensor devices or saved on the smart device that is in communication with the one or more sensor devices. The step of capturing the pitch and roll angle measurements from the sensor device can comprise communicating calibration data from the sensor device of the pitch and roll angle measurements measured by the sensor device when the vehicle is at the initial level position to the smart device and saving the calibration data on the smart device. The step of capturing the pitch and roll angle measurements from the sensor device can comprise saving the calibration data of the pitch and roll angle measurements measured by the sensor device when the vehicle is at the initial level position on the sensor device. The calibration data is saved on the sensor device, the step of saving the calibration data of the pitch and roll angle measurements on the sensor device can comprise transmitting instructions from the smart device to the sensor device to save and store the calibration data of the pitch and roll angle measurements on the sensor device. The steps performed by the software application can include recalling the calibration data of the pitch and roll angle measurements from the sensor device to the smart device.

The step 268 of providing audible or other human sensory feedback in accordance with FIG. 7 of the calculated change in at least one of the pitch direction or the roll direction of the vehicle can comprise displaying or providing audible or other human sensory feedback of the calculated change in the pitch direction and the roll direction of the vehicle in measurements of distance. The step of providing audible or other human sensory feedback of the calculated change in at least one of the pitch direction or the roll direction of the vehicle can comprise displaying or providing audible or other human sensory feedback of the calculated change in the pitch direction and the roll direction of the vehicle as angles.

The steps of the software application can additionally comprise providing a conversion function to permit the changing of the system used for measurements between U.S. Customary System and the Metric System. The steps of the software application can additionally comprise saving a given pitch angle measurement on at least one of the smart devices or the sensor device to permit later recall for the purpose of returning the vehicle to the given pitch angle position at a later time. The steps of the software application can further comprise collecting and storing positional movement information of the vehicle using a global positioning system sensor on the sensor device.

The steps of the software application can additionally comprise receiving data at the smart device from one or more vehicle control panels. The received data from one or more vehicle control panels can comprise at least one of data regarding holding tank levels or data regarding battery power levels. The smart device can display the data that is generated and displayed or provided on the one or more vehicle control panels or providing audible or other human sensory feedback in accordance with FIG. 7.

The software location can also comprise a method to give the leveling system user control over the battery life of the sensor battery to allow the user to extend the life of the battery in use. The sensor device, i.e., the vehicle leveling device, can be configured to switch between a “sleep mode,” where the sensor device is using a minimal amount of power and an “awake mode,” where the sensor device is prepared to perform its variety of actions and can connect with the smart device. The steps of the software application can additionally comprise steps that activate the battery for use through the detection of motion of the vehicle, such as an RV through communication with the sensor device. The sensor device, i.e., the vehicle leveling device, of the leveling system can use motion detected by the accelerometers to change the state of the sensor device between the sleep mode and the awake mode based on certain conditions and user configuration settings. When the sensor device detects motion, the sensor device can transition from the sleep mode to the awake mode and can be connected to the smart device for communication with the leveling system software application. When in the awake mode the Bluetooth signal is being broadcast which uses more battery power than the sleep mode where the Bluetooth signal is not being broadcast. When the sensor device detects no motion based on a user defined period of time, the sensor goes into the sleep mode to conserve the battery, The software application permits the user to define the amount of time, in minutes and/or hours, after no motion is detected that the sensor device will stay in the awake mode before going to the sleep mode. The leveling system user can be allowed to configure the leveling system to best suit the user's specific use habits. The software application can provide one or more screen displays that can allow the user to select a motion detection option to transition the sensor device between an awake mode and a sleep mode and can further provide a method of conserving battery life of the sensor device. The software application can provide audible or other human sensory feedback in accordance with FIG. 7.

An additional aspect that can be employed in some embodiments of the sensor device of the leveling system to conserve battery life is an On/Off switch that is a complete battery disconnect from a circuitry perspective within the sensor device. The battery disconnect can allow the user to turn off the system entirely (to increase battery life) when the sensor is in a setting where motion is constantly being observed, such as when driving or towing the RV for many hours during travel, It can also be used to completely disconnect the battery during RV storage periods. The sensor device can comprise an On/Off switch that permits the disconnection of the battery from the circuitry, for example, from a PCB of the sensor device as described above, of the sensor device to conserve battery life, The sensor can also comprise a sounder device that can be mounted on a PCB of the sensor device that chirps an audible sound when the On/Off switch is moved into the On position, The audible sound can be used to indicate that the currently installed battery is still good. In some embodiments, the audible sound can be used to indicate that the sensor is now in a Bluetooth pairing mode. Pairing mode can be used to associate the original or additional smart device with a given sensor device of the leveling system.

The leveling system and software application can provide a custom pairing mode to associate the sensor device of a given leveling system with a specific smart device. The sensor device of a leveling system can be assigned a serial number. During configuration of the software application and/or installation of the sensor device, the serial number from the sensor can be recorded on the smart device. Once a smartphone or tablet has been associated with a particular sensor, then it will only communicate with that sensor, until it is changed by the user. In this manner, the sensor device of a leveling system on an RV can be assured to connect to the RV user's smart device and not to other possible sensors within a given camping area. The software application can provide a screen display or audible or other human sensory feedback in accordance with FIG. 7 that will allow the user to enter the serial number for the sensor device of the leveling system installed on the RV into the smart device. Once the serial number for that sensor device has been entered, the smart device of the user when using the software application will communicate with the sensor device of the leveling system installed on the RV of the user and not some other sensor device within the area where the RV is being set up for use.

Another aspect of the leveling system and the software application for the leveling system that some embodiment may have, is the ability of the user to define the driver's side of the vehicle, By being able to define which side of the RV is the driver's side, especially for motorized RVs, the leveling system can be used in a variety of countries regardless of the types of cars used within a particular country and the country's laws regarding which side of road a vehicle is driven on. By allowing the leveling system user to select the driver's side of his or her RV, the same leveling system and leveling system software application can be used in countries that require vehicles to be driven on the right side of the road or in countries that require vehicles to be driven on the left side of the road. The software application can include a default setting that the driver's side of the RV is on the left side of the vehicle and the passenger's side is on the right of the vehicle. The software application can include a screen display or audible or other human sensory feedback in accordance with FIG. 7 that will allow the user to change the default setting of the driver's side or allow the user to select which side is the driver's side and/or passenger side of the RV. Once the driver's side is changed or selected, the references for the driver's side and the passenger's side of the RV are set for use with the particular RV so that software application reads properly for that user. The references can also change for the installation orientation selections to match the currently selected driver's side of the vehicle,

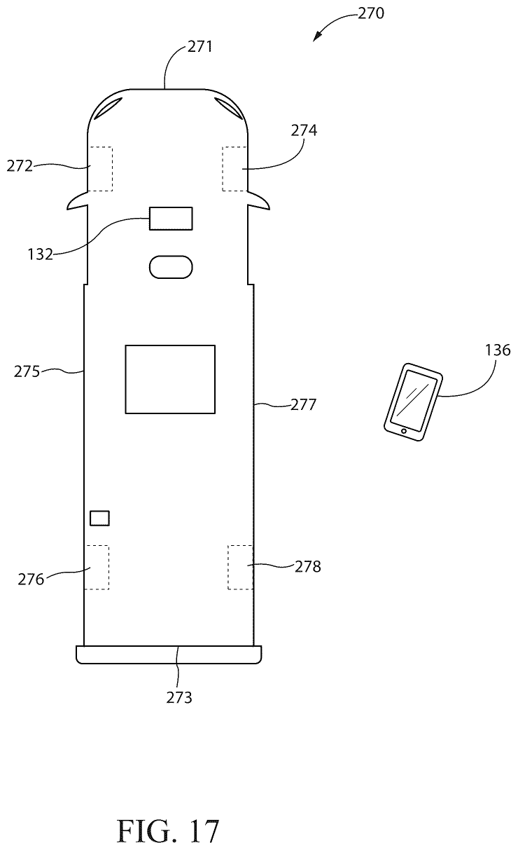

The vehicle leveling devices and leveling systems can be used on either towable recreational vehicles or motorized recreational vehicles. Another specific embodiment of a leveling system and software application is described with reference to FIG. 17. A motorized RV 270 having a front 271, a rear 273, a driver side (first section) 275, and a passenger side (second section) 277 can be provided that can be adjusted in pitch rotational directions depend on the inclination of the RV 70 from front-to-back and roll rotational directions depending on the inclination of RV 270 from side-to-side using leveling systems and devices in a similar manner as described above. RV 270 can comprise a front driver side wheel 272, a front passenger side wheel 274, a rear driver side wheel 276, and a rear passenger side wheel 278, To accomplish the adjustments so that, upon parking RV 270, the RV will be leveled in both the pitch and roll directions, leveling system 140 can be provided that provides measurements to determine the amount of adjustment needed in both the pitch and roll directions. The leveling system 140 can comprise one or more sensor devices 132 (shown schematically in dotted lines as a box within RV 270) that can be secured to RV 270 to sense the inclination and/or orientation of RV 270 in both the pitch and roll directions. The sensor device 132 can comprise a vehicle leveling device.

Leveling system 140 can also comprise smart device 136 that can be in communication with sensor device 132. Components having a similar function are assigned the same reference number. Smart device 136 can have a specific software application thereon that includes one or more aspects of the software application described above that allows information received from sensor device 132 about the inclination and/or orientation of RV 270 to be processed to provide measurements to a user and to determine the number of adjustments needed to RV 270. Smart device 136 and sensor device 132 can communicate with each other in a variety of ways. Sensor device 132 and smart device 136 can communicate through a wired connection or through wireless communications, such as Bluetooth and cellular.

Once leveling system 140 has calculated the change of elevation height needed in the roll direction and the pitch direction, the smart device can determine how much each tire needs to be raised to level RV 270. The software application can display on the smart device or provide by audible or other human sensory feedback in accordance with FIG. 7, the height required to reach a level position for each wheel 272, 274, 276, 278. Those heights are calculated in a similar manner to the calculated roll and pitch elevation heights as described in the embodiments above. The audible or other human sensory feedback can provide the amount of adjustment in height of each wheel 272, 274, 276, 278 of the motorized RV 70 based on the measurements taken by the vehicle leveling device 140 and the calculations of the changes in height needed in the roll direction and the pitch direction.

If the calculated roll height required is an upward elevation on the passenger side of 5.7 cm and the calculated pitch height required is an upward elevation in the rear of 3.8 cm, then either smart device 136 or sensor device 132 can calculate the movement needed for each wheel of RV 270 using the information. Based on these adjustment calculations for the change in the height needed in the roll direction and the pitch direction, the adjustment height of each wheel 272, 274, 276, 278 can be calculated by either smart device 136 or sensor device 132. Smart device 136 or sensor device 132 can determine which wheel would be considered the pivot point, i.e., the wheel that needs no adjustment for RV 270 to reach a level position.

The driver side front wheel would be the pivot point and the audible or other human sensory feedback in accordance with FIG. 7 from the software application on screen of the smart device would announce a zero (0) cm height adjustment of the frame of the motorized RV 270 required at or near the driver front wheel 272, since motorized RV 270 needs an adjustment of height 5.7 cm as explained above on the passenger side 277 and an adjustment of height 3.8 cm as explained above in rear 273 of RV 270. Based on the measurements made by sensor device 132, smart device 136 or sensor device 132 can also determine the change in elevation of height of the frame of the motorized RV 270 required at or near the other three wheels 274, 276, 278. The frame of the motorized RV 270 at or near the passenger front wheel 274 would need a 5.7 cm adjustment in height as provided by audible or other human sensory feedback and the frame of the motorized RV 270 at or near the passenger side rear wheel would need a 9.5 cm adjustment in height as provided by audible or other human sensory feedback, while the frame of the motorized RV 270 at or near the driver side rear wheel 276 would need a 3.8 cm adjustment in height as provide by audible or other human sensory feedback.

The adjustment of height to the frame of the motorized RV 70 proximate to each wheel 272, 274, 276, 278 of RV 270 can be accomplished in different manners. Wheels 272, 274, 276, 278 of RV 270 can be placed or driven onto blocks or stacks of blocks. RV 270 can have one or more jacks 120a-120d that can extend downward from the frame proximate to wheels 272, 274, 276, 278 of RV 270 that can be used to adjust the height of the frame of RV 270. One or more jacks 120a-120d can be placed proximate to wheels 272, 274, 276, 278 of RV 270 to adjust the height of the frame of RV 270.

The calculated adjustment proximate to each wheel is the sum of the calculated change in the height in the roll direction and the pitch direction for the given position of the respective wheel. The calculated change in height of the frame of the motorized RV 270 proximate to the front driver side wheel 272 is the sum of any calculated adjustment in height at front 271 of RV 270 and on driver side 275 of RV 270. The calculated change in height of the frame of the motorized RV 270 proximate to front passenger side wheel 274 is the sum of any calculated adjustment in height at front 271 of RV 270 and on passenger side 277 of RV 270. The calculated change in height of the frame of the motorized RV 270 proximate to rear driver side wheel 276 is the sum of any calculated adjustment in height at rear 273 of RV 270 and on driver side 275 of RV 270, while the calculated change in height of the frame of the motorized RV 270 proximate to rear passenger side wheel 278 is the sum of any calculated adjustment in height at rear 273 of RV 270 and on passenger side 277 of RV 270.

RV 100 or 270 may experience load shifting within the vehicle, either while in motion or while stationary. The load shifting can create an imbalance or deviation from true level within the vehicle. The load shifting can be caused by movement of cargo, intended or not, additional cargo being added, water tanks being emptied or filled, and water accumulation, e.g., from a leak. In other situations, the level of RV 100 or 270 can shift due to external factors, such as high wind, soft ground from rain, or time on location. The software application can provide audible or other human sensory feedback in accordance with FIG. 7 of the need to and how to re-level or otherwise adjust the level to re-establish true level. When searching for a campsite, the software application can provide audible or other human sensory feedback advising the user of the most level site to set up the RV. Choosing a good site to level from helps simplify the leveling process. Once identified, the software can record the geo-locations and coordinates of the most preferred sites or spaces within a particular campground for future reference and drive or roll to level. The software application can provide audible or other human sensory feedback in accordance with FIG. 7 can find a level spot enabled by the gyro, which is highly desired by users because they do not need to keep stopping to check for level.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only and is not intended to limit the present subject matter.

What is claimed:

1. A vehicle leveling system, comprising:
a sensor for sensing a level state of a vehicle based on a calibration state; and
a smart device in communication with the sensor providing audible or human sensory feedback as to the level state of the vehicle.

2. The vehicle leveling system of claim 1, wherein the audible or human sensory feedback includes an audible tone.

3. The vehicle leveling system of claim 2, wherein the audible tone includes a varying frequency.

4. The vehicle leveling system of claim 1, wherein the audible or human sensory feedback includes voice.

5. The vehicle leveling system of claim 1, wherein the audible or human sensory feedback includes light.

6. The vehicle leveling system of claim 1, wherein the audible or human sensory feedback includes haptic.

7. A vehicle leveling system, comprising:
a sensor for sensing a state of levelness of a vehicle; and
a smart device in communication with the sensor providing audible or human sensory feedback as to the state of levelness.

8. The vehicle leveling system of claim 7, wherein the audible or human sensory feedback includes an audible tone.

9. The vehicle leveling system of claim 8, wherein the audible tone includes a varying frequency.

10. The vehicle leveling system of claim 7, wherein the audible or human sensory feedback includes voice.

11. The vehicle leveling system of claim 7, wherein the audible or human sensory feedback includes light.

12. The vehicle leveling system of claim 7, wherein the audible or human sensory feedback includes haptic.

13. The vehicle leveling system of claim 7, wherein the levelness of a vehicle calibration state is based on a calibration state.

14. A method of leveling a vehicle, comprising:
sensing a state of levelness of a vehicle; and
providing audible or human sensory feedback to a user as to the state of levelness.

15. The method of claim 14, wherein the audible or human sensory feedback includes an audible tone.

16. The method of claim 15, wherein the audible tone includes a varying frequency.

17. The method of claim 14, wherein the audible or human sensory feedback includes voice.

18. The method of claim 14, wherein the audible or human sensory feedback includes light.

19. The method of claim 14, wherein the audible or human sensory feedback includes haptic.

20. The method of claim 14, wherein the levelness of a vehicle calibration state is based on a calibration state.
